(19) United States
(12) Patent Application Publication
(10) Pub. No.: US 2018/0032585 A1
(43) Pub. Date: Feb. 1, 2018

(54) SYSTEMS AND METHODS FOR CONTEXT-BASED CONTACT SUGGESTION

(71) Applicant: QUALCOMM Incorporated, San Diego, CA (US)

(72) Inventor: Pavan Kumar Kadiyala, Hyderabad (IN)

(21) Appl. No.: 15/225,506

(22) Filed: Aug. 1, 2016

(51) Int. Cl. G06F 17/30; G06N 7/00; H04W 8/18; G06N 99/00; H04M 1/2745; H04M 1/725

(52) U.S. Cl. CPC G06F 17/30528; H04M 1/274583; H04M 1/72563; H04W 8/183; G06F 17/3097; G06N 99/005; G06N 7/005

(57) ABSTRACT

A method for context-based contact suggestion performed by an electronic device is described. The method includes generating one or more suggested contacts based on current operating context information, historical operating context information, and contact information by determining at least one contextual similarity between the current operating context information and historical operating context information corresponding to at least one contact. The method also includes associating the current operating context information with the contact information. The method further includes updating the historical operating context information based on the current operating context information associated with the contact information.

### TECHNICAL FIELD

The present disclosure relates generally to electronic devices. More specifically, the present disclosure relates to systems and methods for context-based contact suggestion.

### BACKGROUND

In the last several decades, the use of electronic devices has become more common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cameras, video camcorders, digital cameras, cellular phones, smartphones, computers, televisions, gaming systems, etc.) utilize one or more sensors. For example, a smartphone may detect touch inputs with a touch sensor and capture digital images utilizing an image sensor.

However, electronic device interaction is often cumbersome. For example, an electronic device may provide irrelevant or unhelpful interactions. As can be observed from this discussion, systems and methods that improve electronic device usefulness may be beneficial.

### SUMMARY

A method for context-based contact suggestion performed by an electronic device is described. The method includes generating one or more suggested contacts based on current operating context information, historical operating context information, and contact information by determining at least one contextual similarity between the current operating context information and historical operating context information corresponding to at least one contact. The method also includes associating the current operating context information with the contact information. The method further includes updating the historical operating context information based on the current operating context information associated with the contact information. The contact information may include a set of locally stored contacts and/or one or more remotely accessed contacts.

Associating the current operating context information with the contact information may include associating at least one contact of the contact information with the current operating context information corresponding to a time or a time range relative to a contact access or a contact selection. Associating the current operating context information with the contact information may include associating a context parameter vector corresponding to a contact access with the contact information.

The method may include determining a statistical distribution of at least one operating context parameter for a contact based on the historical operating context information. Generating one or more suggested contacts may include determining a selection probability for selecting the contact based on the statistical distribution and the current operating context information.

The historical operating context information may include one or more operating context parameter tables. Determining the at least one contextual similarity may include searching the one or more operating context parameter tables based on at least one current operating context parameter.

Generating one or more suggested contacts may include prioritizing at least two contacts based on the current operating context information and the historical operating context information. Generating the one or more suggested contacts may be based on machine learning. Updating the historical operating context information may include updating machine learning. The method may include generating at least one additional suggested contact based on the current operating context information and the contact information without regard to the historical operating context information.

The historical operating context information may include one or more times, one or more locations, one or more browsing activities, one or more days, one or more dates, one or more seasons, one or more events, one or more network indicators, one or more network communications and/or one or more sensor information. The current operating context information may include a time, a location, one or more browsing activities, a day, a date, a season, one or more events, one or more network indicators, one or more network communications and/or one or more sensor information.

An electronic device for context-based contact suggestion is also described. The electronic device includes a memory configured to store historical operating context information. The electronic device also includes a processor. The processor is configured to generate one or more suggested contacts based on current operating context information, the historical operating context information, and contact information by determining at least one contextual similarity between the current operating context information and historical operating context information corresponding to at least one contact. The processor is also configured to associate the current operating context information with the contact information. The processor is additionally configured to update the historical operating context information based on the current operating context information associated with the contact information.

A computer-program product for context-based contact suggestion is also described. The computer-program product includes a non-transitory computer-readable medium with instructions. The instructions include code for causing an electronic device to generate one or more suggested contacts based on current operating context information, the historical operating context information, and contact information by determining at least one contextual similarity between the current operating context information and historical operating context information corresponding to at least one contact. The instructions also include code for causing the electronic device to associate the current operating context information with the contact information. The instructions further include code for causing the electronic device to update the historical operating context information based on the current operating context information associated with the contact information.

### BRIEF DESCRIPTION OF THE DRAWINGS

FIG. 1 is a block diagram illustrating one configuration of an electronic device in which systems and methods for context-based contact suggestion may be implemented;

FIG. 2 is a flow diagram illustrating one configuration of a method for context-based contact suggestion;

FIG. 3 is a block diagram illustrating a more specific example of an electronic device in which systems and methods for context-based contact suggestion may be implemented;

FIG. 4 is a flow diagram illustrating a more specific configuration of a method for context-based contact suggestion;

FIG. 5 is a flow diagram illustrating another more specific configuration of a method for context-based contact suggestion;

FIG. 6 is a diagram illustrating an example of historical operating context information that may be utilized in accordance with the systems and methods disclosed herein; and

FIG. 7 illustrates certain components that may be included within an electronic device.

### DETAILED DESCRIPTION

Some configurations of the systems and methods disclosed herein may relate to providing an enhanced user experience for contact suggestions. The call history on mobile phones is typically static in nature. For example, the call history may show a recent call history in ascending order of time call. Or, contacts may be provided as pinned static contacts. For example, a user may pin a home land line contact as a frequent contact for speed dial. This may be useful when a user is out of the home, but may not be very useful while the user is spending weekends at home. In another example, a user may want to call a particular number at a specific time (e.g., calling home after lunch or calling a colleague for lunch/coffee, etc.). However, all of the recent call history and/or frequent call history may not be useful for that particular time.

Suggested contacts may be much more useful with dynamic behavior. For example, if the user is not feeling well and/or is using a search engine to know about medicines or hospitals in that situation, potentially useful contacts may include doctor(s)/health expert(s). The doctor(s)/health expert(s) may be dynamically listed as suggested contacts (where the doctor(s)/health expert(s) may be drawn from a predetermined list and/or may be determined on the fly, for instance). In another example, a user may call his tennis partner daily in the morning for practice, regardless of last night's recent calls. In this case, it would be useful for suggested contacts to include his tennis partner in the mornings.

Some configurations of the systems and methods disclosed herein may utilize machine learning to determine which suggested contacts (e.g., list) to be shown. For example, the suggested contacts may appear in addition to or alternatively from frequent/recent call history. The systems and methods disclosed herein may be implemented on an electronic device (e.g., mobile device). Machine learning may include building a set of information (e.g., a database of facts) and/or making decisions from analyzing the set of information (e.g., the facts from the built database). For example, machine learning may include building a set of operating context information and/or making decisions based on the set of operating context information. In some configurations of the systems and methods disclosed herein, for example, one or more tables may be built on each mobile originated/mobile terminated (MO/MT) call and/or each incoming or outgoing message. Machine learning may include making intelligent decisions after the analysis of the facts (e.g., at the time of a mobile originated (MO) call or outgoing message).

The machine learning may be based on (e.g., may consider) operating context information (e.g., one or more operating context parameters). Examples of operating context parameters may include times of phone calls, Global Positioning System (GPS) location, connected Wi-Fi name(s) during phone calls, days in the week, etc. The operating context parameters may be extended to Internet of Things (IoT) features like recently searched items, body health condition, current emotion, etc. With this kind of intelligence built in, an electronic device (e.g., mobile device) may enhance the user experience by suggesting one or more appropriate contacts to the user for a particular time, location, and/or situation.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

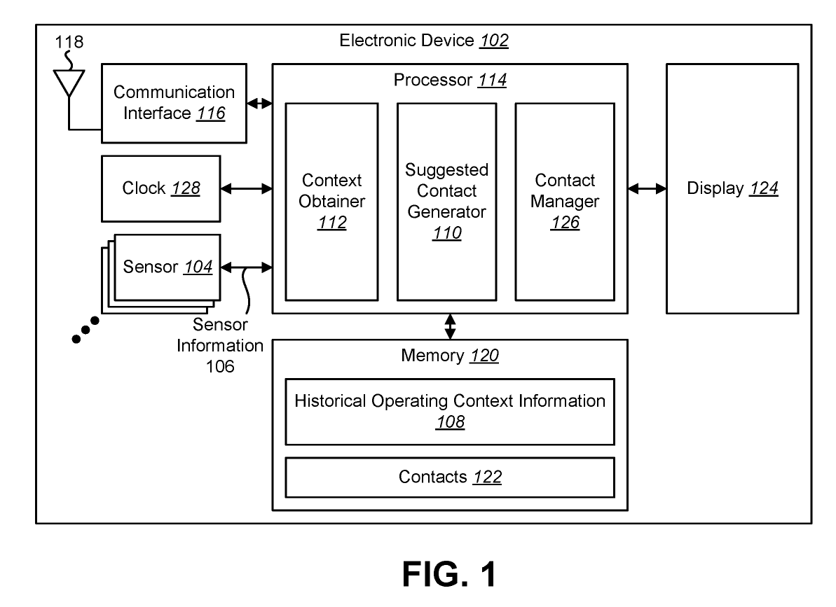

FIG. 1 is a block diagram illustrating one configuration of an electronic device 102 in which systems and methods for context-based contact suggestion may be implemented. Examples of the electronic device 102 include wireless communication devices, laptop computers, desktop computers, cellular phones, smartphones, wireless modems, e-readers, tablet devices, gaming systems, televisions, appliances, automobiles (e.g., automobile consoles), etc. In some configurations, the electronic device 102 may be referred to as a wireless communication device, a mobile device, mobile station, subscriber station, client, client station, user equipment (UE), remote station, access terminal, mobile terminal, terminal, user terminal, subscriber unit, etc.

The electronic device 102 may include one or more sensors 104, a processor 114, a memory 120, a display 124, a clock 128, a communication interface 116 and/or one or more antennas 118. One or more of the sensors 104, the memory 120, the display 124 and the communication interface 116 may be coupled to (e.g., in electronic communication with) the processor 114. One or more of the components of the electronic device may be implemented in hardware or in hardware with software and/or firmware (e.g., in a processor with instructions). It should be noted that one or more of the components or elements of the electronic device 102 may be optional in some configurations. For example, some configurations of the electronic device 102 may not include an antenna 118, communication interface 116 and/or a display 124.

The communication interface 116 may enable the electronic device 102 to communicate with one or more other electronic devices. For example, the communication interface 116 may provide an interface for wired (e.g., Ethernet, Universal Serial Bus (USB), phone line, etc.), and/or wireless (e.g., cellular, Long Term Evolution (LTE), CDMA, Institute of Electrical and Electronics Engineers (IEEE) 802.11 (Wi-Fi), Bluetooth, Zigbee, etc.) communications. In some configurations, the communication interface 116 may be coupled to one or more antennas 118 for transmitting and/or receiving radio frequency (RF) signals.

The display 124 may present one or more images. In some configurations, the display 124 may present a user interface for interaction. For example, the display 124 may present one or more buttons, icons, text, links, etc. In some implementations, the display 124 may be a touchscreen display. For instance, the electronic device 102 may receive user input via the touchscreen display.

The one or more sensors 104 may obtain sensor information 106. For example, the one or more sensors 104 may sense or detect information regarding context (e.g., the situation of, surroundings of, status of and/or usage of the electronic device 102). Examples of the one or more sensors 104 include one or more image sensors (e.g., cameras), audio sensors (e.g., microphones), ambient light sensors, location (e.g., Global Positioning System (GPS), Wi-Fi positioning system, etc.) sensors, motion sensors (e.g., accelerometers, etc.), touch sensors, heat sensors, pressure sensors, proximity sensors, barometric pressure sensors and/or tilt sensors, etc.

The one or more sensors 104 may generate sensor information 106. Sensor information 106 may indicate information regarding context (e.g., the situation, surroundings, status of and/or usage of the electronic device 102). For example, the sensor information 106 may include image information (e.g., pixel data), audio information, location information (e.g., coordinates, latitude and longitude, etc.), motion information, ambient light information, device pressure (e.g., a force exerted on the electronic device 102) information, barometric pressure information and/or orientation information (e.g., electronic device tilt, device pointing direction, camera pointing direction, etc.), etc. The sensor information 106 may be provided to the processor 114.

The memory 120 may store information (e.g., data). For example, the memory 120 may store historical operating context information 108 and/or contacts 122 (e.g., locally stored contacts). The processor 114 may access (e.g., read data from, write data to, etc.) the memory 120. For example, the processor 114 (e.g., the context obtainer 112 and/or suggested contact generator 110) may access the historical operating context information 108.

In some configurations, the electronic device 102 may include a clock 128. The clock may indicate temporal information. The temporal information may indicate and/or may be utilized to determine one or more times (e.g., time of day, day of the week, month, year, etc.). The temporal information may be provided to the processor 114 (e.g., context obtainer 112) in some configurations. In some implementations, the clock 128 may be included in (e.g., integrated into) the processor 114. Additionally or alternatively, the electronic device 102 may obtain temporal information from a remote device (via the communication interface 116, for example). For instance, the electronic device 102 may request and/or receive temporal information (e.g., time of day, day of the week, month, year, etc.) from a remote device.

An “operating context” may relate to the circumstances in which the electronic device 102 operates. For example, an operating context may relate to times when one or more operations are performed, which operation(s) are performed, data involved in the operation(s), where the electronic device 102 is located, event(s) occurring on and/or around the electronic device 102, reasons for why the electronic device 102 is being used, user behavior, etc. Operating context information may provide indications of an operating context and/or data pertaining to the operating context.

The processor 114 may include and/or implement a context obtainer 112. The context obtainer 112 may obtain operating context information (e.g., current operating context information, historical operating context information, etc.). For example, the context obtainer 112 may obtain operating context information from the communication interface 116, from the sensor(s) 104, from the memory 120 (e.g., historical operating context information 108), from the electronic device 102 and/or from the processor 114. The operating context information may include current operating context information and/or historical operating context information 108.

Operating context information (e.g., one or more operating context parameters) may indicate and/or relate to the situation of, surroundings of, status of and/or usage of the electronic device 102. Examples of operating context information (e.g., operating context parameters) may include one or more times (e.g., times of contact accesses, text messages, phone calls, etc.), one or more locations (e.g., Global Positioning System (GPS) location and/or connected network(s) (e.g., Wi-Fi name, base station identifier, etc.)), one or more days (e.g., days in the week, Monday, Tuesday, Wednesday, etc.), application information (e.g., one or more browsing activities (e.g., one or more search terms, visited websites, Uniform Resource Locators (URLs), etc.)), one or more dates (e.g., month, day, and/or year), one or more seasons (e.g., fall, winter, spring, summer, sports seasons, school year, term, semester, hunting season, etc.), one or more events (e.g., birthdays, holidays, anniversaries, tax day, bowl games, tournaments, graduation, etc.), one or more network indicators (e.g., Wi-Fi network name, Bluetooth network, cellular network, mesh networks, ad-hoc networks, etc.), one or more network communications (e.g., data from one or more network devices, data from Internet of Things (IoT) devices, data from web servers, data from a networked vehicle, etc.), and/or one or more sensor information 106 (e.g., biometric sensor data, touch sensor data, audio sensor (e.g., microphone) data, pressure sensor data, motion sensor (e.g., accelerometer, gyro, etc.) data, light sensor (e.g., camera) data, image data, moisture sensor data, temperature sensor data, weather sensor data (e.g., anemometer sensor data, etc.), activity sensor data (e.g., walking/running distance, sleep quantity, etc.), health sensor data (e.g., heart sensor data, respiration sensor data, etc.), emotion sensor data, etc.), etc. It should be noted that some operating context information may be obtained based on one or more public calendars, one or more private calendars, one or more appointment schedules, etc. For example, the electronic device 102 (e.g., context obtainer 112) may access one or more network locations (e.g., web pages) and/or local memory 120 in order to access some types of information (e.g., events, appointments, seasons, schedules, etc.). It should be noted that the operating context information may include information that is based on (e.g., derived from) one or more of the aforementioned types of information. For example, the electronic device 102 (e.g., context obtainer) may determine a user emotion based on audio sensor information, image sensor information and/or application information (e.g., browsing activity, etc.).

In some configurations, the context obtainer 112 may determine whether the electronic device 102 is located in a particular country, state, city, county, town, park and/or recreational area (e.g., national park, tourist attraction, wilderness area, beach, ski resort, etc.), etc. Additionally or alternatively, the context obtainer 112 may determine whether the electronic device 102 is nearby or inside of a structure (e.g., business such as a mall, restaurant, grocery store, retail store, etc.). Additionally or alternatively, the context obtainer 112 may determine whether the electronic device 102 is traveling along a particular route (e.g., road, highway, interstate, trail, etc.).

In some configurations, the context obtainer 112 may perform motion recognition on motion sensor data and/or classify the motion sensor data. For example, the context obtainer 112 may determine whether the user of the electronic device 102 is walking, jogging, running, exercising and/or traveling (in a car, train, boat, airplane, etc.), etc.

The context obtainer 112 may obtain the operating context information relative to a time of (and/or relative to a time range around) contact access and/or contact selection (for a phone call, text message, email, etc., for instance). For example, operating context information may be associated with a contact access and/or contact selection if the operating context information occurs and/or is obtained at approximately a time of contact access and/or contact selection (and/or within the time range around contact access and/or contact selection). The time range may include a period before, during, and/or after a contact access and/or contact selection.

Contact information may include one or more locally stored contacts 122 and/or one or more remotely accessed contacts. Contact information may include information corresponding to one or more contacts. For example, contact information may include one or more of a name, phone number, email address, business name, relationship (e.g., mother, father, sibling, child, friend, extended family, etc.), profession, title, image, etc., of a contact (e.g., person, business, etc.). In some configurations, the locally stored contacts 122 may include one or more contacts that have been entered and/or selected based on user input. The contacts 122 may include one or more designated contacts, such as a primary emergency contact, a lost device contact, family physician, etc.

A contact access may occur when the electronic device 102 accesses contact information. In some configurations and/or cases, a contact access may occur when the electronic device 102 receives and/or processes a request to access contact information (e.g., locally stored contacts 122 or remotely accessed contacts). For example, a contact access may occur when the electronic device 102 receives an input (e.g., a touchscreen display 124 receives a touch, a mouse receives a click, a microphone receives a voice command, etc.) indicating a request for contact information.

A contact selection may occur when the electronic device 102 selects contact information (e.g., one or more locally stored contacts 122 and/or one or more remotely accessed contacts). In some configurations and/or cases, a contact selection may occur when the electronic device 102 receives and/or processes a request to select contact information (e.g., locally stored contact(s) 122 or remotely accessed contact(s)). For example, a contact selection may occur when the electronic device 102 receives an input (e.g., a touchscreen display 124 receives a touch, a mouse receives a click, a microphone receives a voice command, etc.) indicating a request to select one or more contacts. The electronic device 102 (e.g., processor 114) may utilize the contact selection to perform one or more operations. For example, the contact selection may be utilized to address and/or send a phone call, text message, email, etc.

Current operating context information may be operating context information (e.g., one or more operating context parameters) corresponding to a most recent contact access and/or contact selection. For example, current operating context information may include a time, a location, one or more browsing activities, a day, a date, a season, one or more events, one or more network indicators, one or more network communications and/or one or more sensor information 106 at the time (or within a time range) of a most recent contact access and/or contact selection.

The processor 114 (e.g., context obtainer 112, contact manager 126, etc.) may associate the current operating context information with contact information. For example, the context obtainer 112 may associate a contact (e.g., one or more locally stored contacts 122 and/or one or more remotely accessed contacts) with operating context information corresponding to a time of (or a time range relative to) a contact access and/or contact selection (e.g., a most recent contact access and/or contact selection).

In some configurations, associating the current operating context information with the contact information may include associating the contact information with one or more operating context parameters (e.g., an operating context parameter vector) corresponding to a contact access and/or a contact selection. For instance, operating context parameters (corresponding to a contact access and/or a contact selection) may be grouped into a context parameter vector. The context parameter vector may be associated with (e.g., linked to, etc.) one or more contacts.

In some approaches, associating the current operating context information with the contact information may include linking the current operating context information to one or more selected contacts and/or one or more unselected contacts. For example, the electronic device 102 may receive one or more indications (e.g., one or more user inputs) that indicate one or more selected contacts (e.g., one or more selected contacts for a phone call, text message, email, etc.). It should be noted that multiple contacts may be selected for a conference call, group text message, email with multiple addressees, etc. The current operating context information (e.g., one or more operating context parameters, an operating context parameter vector, etc.) may be linked to the selected and/or unselected contact(s) by setting one or more variables that address the current operating context information and the selected and/or unselected contact(s). For example, the electronic device 102 may set a variable that includes pointers to the contact(s) and the current operating context information. Additionally or alternatively, the electronic device 102 may create an object that includes (e.g., references) the contact(s) and the current operating context information.

Historical operating context information 108 may be a set of operating context information (e.g., operating context parameters) obtained in relation to one or more contact accesses and/or contact selections. For example, historical operating context information 108 may include one or more times, one or more locations, one or more browsing activities, one or more days, one or more dates, one or more seasons, one or more events, one or more network indicators, one or more network communications (e.g., networked vehicle information, etc.) and/or one or more sensor information 106 corresponding to one or more contact accesses and/or contact selections. For instance, each time current operating context information is obtained, the historical operating context information 108 may be updated.

In some configurations, the historical operating context information 108 may be organized and/or stored in accordance with one or more data structures. In one example, the historical operating context information 108 (e.g., context parameter(s)) may be stored in one or more data structures (e.g., table(s), array(s), list(s), tree(s), etc.), where one or more contacts are associated with each instance of context information (e.g., context parameter vector). Additionally or alternatively, the historical operating context information 108 may be stored in one or more data structures (e.g., table(s), array(s), list(s), tree(s), etc.) where statistical distributions (of one or more context parameters, for example) are associated with each contact. The processor 114 (e.g., context obtainer 112 and/or suggested contact generator 110) may determine a statistical distribution of at least one context parameter for a contact based on operating context information (e.g., historical operating context information 108). In some configurations, the historical operating context information 108 may indicate whether a contact was selected and/or was not selected in association with a portion (e.g., a contact selection instance) of or all of the historical operating context information 108. Additionally or alternatively, the historical operating context information 108 may indicate a number of times that a contact has been (and/or has not been) selected in association with a portion (e.g., a contact selection instance, one or more operating context parameters, one or operating context parameter vectors, etc.) of or all of the historical operating context information 108.

In some configurations, the historical operating context information 108 may be structured as a database that includes operating context information tables. For example, the database may be built on the electronic device 102 (e.g., smartphone, laptop, tablet device, etc.). Building the historical operating context information 108 may be a continuous procedure. For example, the historical operating context information 108 may be updated each time the electronic device 102 accesses contact(s), selects contact(s) and/or performs an operation (e.g., updated on each mobile originated/mobile terminated (MO/MT) call or message).

The operating context information tables may be built with a context key. For example, a time-based table may include a time interval as a primary key and contacts as secondary columns. For instance, the contacts in the time-based table may be searched based on the time attribute. Examples of other tables that may be included in the historical operating context information 108 may include a location-based table, a weather-based (e.g., climate-based) table, a current Wi-Fi network-based table, a health-based table, mood-based table(s) (e.g., emotion-based table), current vehicle-based table, etc. In some configurations, the historical operating context information 108 may include a global table that maintains priority information for all the operating context information tables. For example, a health condition-based table may be given higher priority. For instance, if the suggested contact generator 110 determines that a user needs health related suggestions, then the priority attribute may help to suggest a health-related contact first in a list of suggested contacts.

In some configurations, the operating context information tables may store a limited amount of information. For example, only 1 month of historical operating context information 108 may be available. Additionally or alternatively, the amount of information in the historical operating context information 108 may be configurable. Additionally or alternatively, the amount of information in the historical operating context information 108 may automatically depend on the memory availability on the electronic device 102 (e.g., phone). Additionally or alternatively, the electronic device 102 may connect to a personal cloud account and get and/or set the amount of information available in the historical operating context information at each access (e.g., iteration for each contact access, contact selection and/or operation (e.g., phone call, text message, email, etc.). The deletion of database table items may be based on an item's age and/or user preferences.

In some configurations, related operating context information may be shared among electronic devices (e.g., phones). For example, employees may share office-related historical operating context information (e.g., tables). In another example, electronic devices of family members may share health-related context information.

The processor 114 may include and/or implement a suggested contact generator 110. The suggested contact generator 110 may generate one or more suggested contacts (e.g., a list of suggested contacts) based on current operating context information, historical operating context information 108 and/or contact information. For example, the suggested contact generator 110 may determine and/or select one or more contacts (e.g., one or more locally stored contacts 122 and/or one or more remotely accessed contacts) as suggested contacts. The suggested contacts may be determined and/or selected based on whether the current contextual information indicates whether one or more contacts may be relevant, may have a contextual similarity to some of the historical operating context information 108 and/or may have a selection probability.

This determination and/or selection may be performed based on the historical operating context information 108. For example, if the current operating context information bears an amount (e.g., a threshold amount) of similarity to historical operating context information 108 when a contact was selected, the suggested contact generator 110 may provide the contact as a suggested contact. In some approaches, the suggested contact generator 110 may order the suggested contacts based on an amount of relevance and/or selection probability. For example, the suggested contact generator 110 may prioritize contacts that have a greater amount of relevance, contextual similarity and/or selection probability. In some examples, when an operation is going to be performed (e.g., when contact(s) are accessed, when contact(s) are selected and/or when a particular operation (such as a phone call or text messaging) is being initiated (e.g., when a user is going to initiate a call)), the electronic device 102 (e.g., suggested contact generator 110) may search through all or part of the historical operating context information 108 and provide one or more suggested contacts. For instance, the suggested contact generator 110 may search through available tables with current operating context information (e.g., location, time, vehicle information, etc.) and may suggest contacts in priority order.

In some configurations, the suggested contact generator 110 may determine an amount of relevance (e.g., a relevance score) for one or more contacts. For example, the suggested contact generator 110 may determine a relevance score for one or more locally stored contacts 122 and/or may determine one or more remotely accessed contacts with corresponding relevance scores. For instance, assume that the current operating context information indicates web searches about an illness, indicates articles accessed on one or more medical websites and/or indicates potential health problems (e.g., irregular heartbeat, elevated temperature, etc.). The suggested contact generator 110 may determine a relevance score for one or more locally stored contacts 122. For example, a user's doctor, a user's emergency contact and/or a user's close family members may have high relevance scores (e.g., may be among a number of top relevance scores and/or may be greater than a relevance threshold, etc.). Additionally or alternatively, the suggested contact generator 110 may determine a relevance score for one or more health care provider contacts located near the electronic device 102 location. For example, the suggested contact generator 110 may determine a medical/health problem context and may search a network (e.g., the Internet) for remotely accessed contacts (e.g., health care providers) within a range from the location indicated in the current operating context. The relevance scores may depend on the current operating context information. For example, an emergency contact (e.g., 911), hospital emergency room contacts and cardiologist contacts may have higher relevance scores than a podiatrist contact if the current context information indicates an irregular heart beat and web searches relating to chest pain.

The suggested contact generator 110 may generate one or more suggested contacts by determining at least one contextual similarity between the current operating context information and historical operating context information 108 corresponding to at least one contact. For example, the suggested contact generator 110 may compare the current operating context information (e.g., one or more current operating context parameters, current operating context parameter vector, etc.) to the historical operating context information (e.g., one or more instances of historical operating context information, historical operating context parameter(s), historical operating context parameter vector(s), historical operating context information corresponding to each contact, etc.). The contextual similarity may indicate how similar the current operating context is to the historical operating context information 108 (e.g., one or more instances of historical operating context information, historical operating context parameter(s), historical operating context parameter vectors, historical operating context information corresponding to each contact, etc.).

Contextual similarity may be determined with one or more approaches. For example, the suggested contact generator 110 may determine (e.g., calculate, compute, etc.) a correlation between the current operating context information (e.g., current operating context parameter(s), current operating context parameter vector(s), etc.) and the historical operating context information 108 (e.g., historical operating context parameter(s), historical operating context vector(s), etc.) corresponding to one or more contacts (e.g., locally stored contacts 122). Additionally or alternatively, the suggested contact generator 110 may determine a distance (e.g., a difference, a Euclidean distance, etc.) between the current operating context information and the historical operating context information 108 (e.g., historical operating context parameter(s), historical operating context vector(s), etc.) corresponding to one or more contacts (e.g., locally stored contact(s) 122, remotely accessed contact(s), etc.). For example, the suggested contact generator 110 may determine a difference between a current operating context parameter and one or more historical operating context parameters. Additionally or alternatively, the suggested contact generator 110 may determine a distance between a current operating context parameter vector and one or more historical operating context parameter vectors in a vector space. Smaller differences and/or shorter distances may indicate higher similarities.

In some configurations, the suggested contact generator 110 may determine one or more selection probabilities for selecting one or more respective contacts based on a statistical distribution and the current operating context information. For example, given the current operating context information and a statistical distribution from the historical operating context information 108 (indicating statistics on whether a particular contact was (and/or was not) selected in association with context information, for instance), the suggested contact generator 110 may determine (e.g., calculate, compute, etc.) probabilities that one or more contacts will be selected. One or more contacts may be suggested based on the corresponding selection probabilities. For example, the suggested contact generator 110 may produce one or more suggested contacts with corresponding selection probabilities that meet or exceed a threshold. Other contact(s) that do not meet the threshold may not be suggested (e.g., may not be provided as suggested contacts).

In some configurations, generating the suggested contacts may be based on a contact sponsor factor. For example, the electronic device 102 may search a network (e.g., the Internet) for suggested contacts based on the current operating context information. A contact may be sponsored. For example, a local restaurant may sponsor a web page to provide contact information for current operating context information (e.g., browser activity, mealtime, etc.) that may indicate that the user is searching for restaurants. The web page may indicate that a contact is sponsored, which may be taken into account by the electronic device 102. For example, the electronic device 102 may prioritize some contacts based on a sponsorship factor.

In some configurations, the suggested contacts may be ordered (in ascending or descending order, for instance) based on corresponding relevance, contextual similarities and/or selection probabilities. For example, the suggested contacts may be ordered from a highest relevance to a lowest relevance (e.g., relevance score). Additionally or alternatively, the suggested contacts may be order from a highest contextual similarity to a lowest contextual similarity. Additionally or alternatively, the suggested contacts may be ordered from a highest selection probability to a lowest selection probability. In some approaches, two or more of the relevance (e.g., relevance score), contextual similarity and selection probability may be combined into a joint score. The suggested contacts may be prioritized based on the joint score. The suggested contacts may be provided to a contact manager 126.

It should be noted that contact suggestion may not always depend on the historical operating context information 108 (e.g., recorded database, recorded facts, etc.). In one situation, for example, contacts 122 (e.g., user-stored contacts) with location information as a contact field and/or contact names may be used for suggested contacts. For instance, a user may store a friend contact as “Peter Hyderabad,” or “John Bangalore.” This information may be useful in suggesting the contacts if the electronic device 102 (e.g., user) located in Hyderabad (which may be identified by current base station information and/or GPS, for example). Accordingly, the suggested contact generator 110 may search through contacts 122 (e.g., contact location fields and/or contact names) to suggest the contacts. If a user travels to particular city, for instance, the suggested contact generator 110 may suggest one or more (e.g., all) contacts related to that city.

In some configurations, if the suggested contact generator 110 does not have any contacts to suggest (based on the historical operating context information, based on the context, etc., for example) then the suggested contact generator 110 may fall back to static solutions (e.g., pinned contacts, recent contact history). This may occur in rare circumstances (e.g., in new phones or formatted phones, etc.).

The processor 114 may include and/or implement a contact manager 126. The contact manager 126 may perform one or more operations based on the suggested contact(s). For example, the contact manager 126 may provide the suggested contact(s) (e.g., prioritized suggested contacts) to the display 124. The suggested contact(s) may be presented on the display 124. For example, the suggested contacts may be presented as a prioritized list (with the highest priority suggested contact at the top of the list, for instance). In some approaches, the electronic device 102 may present an indicator of one or more of the suggested contacts as a button, icon and/or text on the display 124 (e.g., touch screen). Additionally or alternatively, the suggested contact(s) may be otherwise presented (e.g., indicated with audio (e.g., read as speech, with an audio chime, etc.)) to a user.

The contact manager 126 may perform additional or alternative operations based on the contact(s) (e.g., locally stored contact(s) 122, remotely accessed contact(s) and/or suggested contact(s)). In some configurations, the contact manager 126 may receive a contact selection indicator. For example, the electronic device 102 (e.g., display 124, communication interface 116, sensor(s) 104, etc.) may receive a contact selection indicator based on user input (e.g., touch, mouse click, speech, motion, etc.), which may be provided to the contact manager 126. The contact selection indicator may indicate a selection of one or more contacts (e.g., locally stored contact(s) 122, remotely accessed contact(s) and/or suggested contact(s)) for performing an operation (e.g., phone call, text message, email, contact storage, etc.). The contact manager 126 may perform the operation (e.g., initiate a phone call, a text message, an email, contact storage, etc.). Additionally or alternatively, the contact manager 126 may run (e.g., open, call and/or execute) one or more applications to perform one or more operations based on the selected contact (e.g., locally stored contact(s) 122, remotely accessed contact(s) and/or suggested contact(s)). For example, the electronic device 102 may perform the operation by opening (or switching to) an application that performs the operation and performing the operation based on the selected contact.

In some configurations, the contact manager 126 may select an operation based on a received input (e.g. user input). For example, the electronic device 102 may receive a user input (e.g., a tap and/or swipe on a touch screen, a mouse click event, a speech recognition input, a motion input, a tilt input, etc.) that indicates a particular operation for one or more contacts (e.g., locally stored contact(s) 122, remotely accessed contact(s) and/or suggested contact(s)). For instance, the electronic device 102 may detect that a user has tapped some text or an icon associated with a suggested contact or another contact that indicates a particular operation (e.g., phone call, text message, email, store contact, edit contact, etc.). In some configurations, the contact manager 126 may run a dialer application, a text message application, an email application and/or a contacts application.

In some configurations, the processor 114 (e.g., context obtainer 112, suggested contact generator 110 and/or contact manager 126) may update the historical operating context information 108 based on the contact selection and/or the operation. For example, context obtainer 112 may store the current operating context information (associated with one or more contacts, for example) as an update to the historical operating context information 108. In some configurations, the contact manager 126 may update the historical operating context information 108 by storing an indication of whether one or more of the contacts (e.g., locally stored contact(s) 122, remotely accessed contact(s) and/or suggested contact(s)) were selected. In some approaches, the contact manager 126 may also store an indication of the operation. In this way, the processor 114 may flexibly update the historical operating context information 108 to more closely reflect a user's behavior. Accordingly, the suggested contacts may be more helpful to a user (particularly as more historical operating context information 108 is collected, for example). For example, the historical operating context information 108 may reflect that a particular contact may be selected more often than another contact in a particular context. The suggested contact generator 110 may accordingly prioritize the suggested contacts. It should be noted that a contact that is not one of the suggested contacts may be selected in some instances. The suggested contact generator 110 may accordingly adjust the historical operating context information 108, which may impact suggested contacts for future contact accesses.

In some configurations, associating the current operating context information with the contact information and updating the historical operating context information may be performed jointly. For example, associating the current operating context information with contact information and updating the historical operating context information may be carried out by storing the current operating context information in a data structure that is associated with one or more contacts. The current operating context information may be added to other instances of historical operating context information that have been previously stored in association with the contact information (e.g., one or more contacts). It should be noted that updating the historical operating context information may include additional or alternative procedures in some configurations. For example, updating the historical operating context information may include determining a statistical distribution as described herein, where the statistical distribution may be added to and/or adjusted based on the current operating context information.

It should be noted that one or more of the elements or components of the electronic device 102 may be combined and/or divided. For example, the context obtainer 112, the suggested contact generator 110 and/or the contact manager 126 may be combined. Additionally or alternatively, one or more of the context obtainer 112, the suggested contact generator 110 and/or the contact manager 126 may be divided into elements or components that perform a subset of the operations thereof.

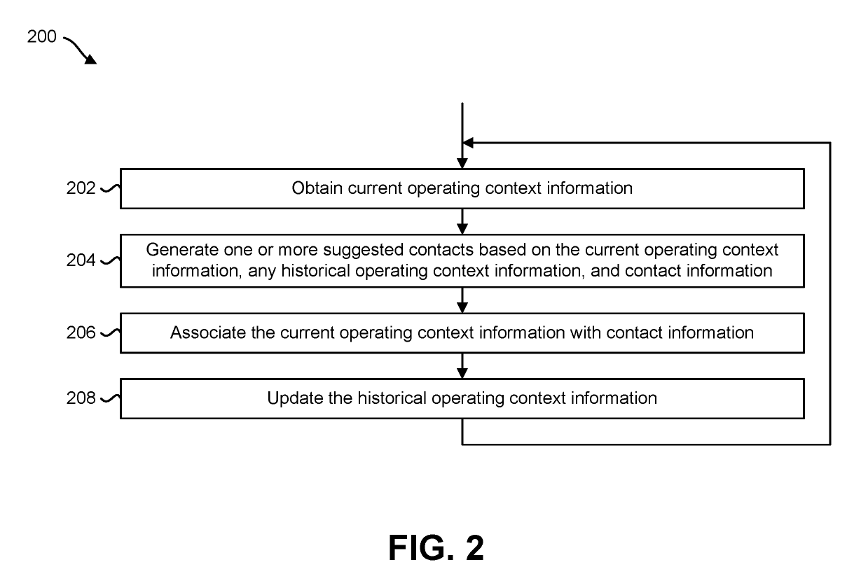

FIG. 2 is a flow diagram illustrating one configuration of a method 200 for context-based contact suggestion. The electronic device 102 described in connection with FIG. 1 may perform the method 200 in some configurations.

The electronic device 102 may obtain 202 current operating context information. This may be accomplished as described in connection with FIG. 1. For example, the electronic device 102 may obtain a time (e.g., a time of a contact access, text message, phone call, etc.), a location, a day, one or more browsing activities, a date, one or more seasons, one or more events, one or more network indicators, one or more network communications and/or one or more sensor information 106, etc. In some configurations, a contact access (e.g., receiving a request to access one or more contacts) may trigger obtaining 202 current operating context information.

The electronic device 102 may generate 204 one or more suggested contacts based on the current operating context information, any historical operating context information, and contact information. This may be accomplished as described in connection with FIG. 1. For example, the electronic device 102 may determine and/or select one or more contacts (e.g., one or more locally stored contacts 122 and/or one or more remotely accessed contacts) based on whether the current contextual information indicates whether one or more contacts may be relevant, may have a contextual similarity to some of the historical operating context information 108 and/or may have a selection probability.

The electronic device 102 may associate 206 the current operating context information with contact information. This may be accomplished as described in connection with FIG. 1. For example, the electronic device 102 may link the current operating context information (e.g., one or more operating context parameters, an operating context parameter vector, etc.) with one or more contacts. For instance, the current operating context information may be linked to one or more selected contacts. Associating the current operating context information with one or more selected contacts may indicate a context in which the contacts may be selected in future instances. Additionally or alternatively, the current operating context information may be linked (e.g., negatively linked) to one or more unselected contacts (e.g., one or more contacts other than the selected contact(s)). Associating the current operating context information with one or more unselected contacts may indicate a context (or differences in context) in which the contacts may not be selected in future instances.

The electronic device 102 may update 208 the historical operating context information. This may be accomplished as described in connection with FIG. 1. For example, the electronic device 102 may update 208 the historical operating context information based on the current operating context information associated with the contact information. In some configurations, updating 208 the historical operating context information may include adding the current operating context information to any pre-existing historical operating context information. For example, the electronic device 102 may add another instance of operating context information to a data structure (e.g., table) that associates one or more contacts with operating context information. In some configurations, the electronic device 102 may determine a statistical distribution based on the current operating context information and/or add the current operating context information to a pre-existing statistical distribution for one or more contacts.

As illustrated in FIG. 2, the method 200 may repeat. In some configurations, the method 200 may repeat for each contact access and/or contact selection.

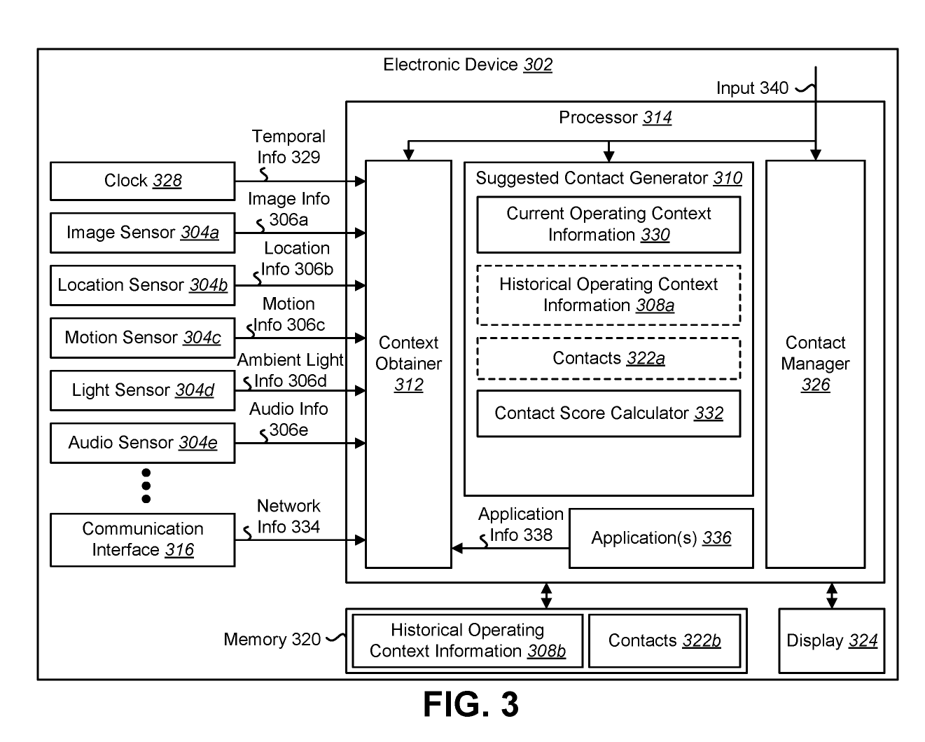

FIG. 3 is a block diagram illustrating a more specific example of an electronic device 302 in which systems and methods for context-based contact suggestion may be implemented. The electronic device 302 may be one example of the electronic device 102 described in connection with FIG. 1. The electronic device 302 may include a clock 328, one or more sensors 304a-e, a processor 314, a memory 320 and/or a display 324. The processor 314 may include and/or implement a context obtainer 312, a suggested contact generator 310, a contact manager 326 and/or one or more applications 336. One or more of the components or elements of the electronic device 302 may be examples of corresponding components or element of the electronic device 102 described in connection with FIG. 1. For example, the context obtainer 312 may be one example of the context obtainer 112 described in connection with FIG. 1.

The memory 320 may store information or data as described above in connection with FIG. 1. For example, historical operating context information 308b and contacts 322b may be stored in the memory 320. The processor 114 (e.g., the context obtainer 312, suggested contact generator 310 and/or contact manager 326) may access (e.g., load) all or part of the historical operating context information 308a and/or contacts 322a.

The electronic device 302 may include a clock 328. The clock 328 may indicate temporal information 329 (e.g., time of day, day of the week, month, year, etc.). The temporal information 329 may be provided to the context obtainer 312. As illustrated in FIG. 3, the electronic device 302 may include an image sensor 304a, a location sensor 304b, a motion sensor 304c, a light sensor 304d (e.g., ambient light sensor) and/or an audio sensor 304e (e.g., one or more microphones). The electronic device 302 may include a communication interface 316. It should be noted that one or more of the clock 328, sensors 304a-e and communication interface 316 may be optional. For instance, the clock 328 may be optional, the communication interface 316 may be optional and fewer or more sensors than those illustrated in FIG. 3 may be implemented in accordance with the systems and methods disclosed herein. Accordingly, more, less and/or different information than the information 306a-e, 329, 334 described in connection with FIG. 3 may be utilized in some configurations.

As described above in connection with FIG. 1, one or more of the sensors 304a-e may sense or detect operating context information regarding the operating context of the electronic device 302. The sensors 304a-e may be examples of the one or more sensors 104 described in connection with FIG. 1. For example, the image sensor 304a may obtain image information 306a (e.g., pixel data), which may include one or more images of the surroundings of the electronic device 302. The location sensor 304b may obtain location information 306b (e.g., coordinates, latitude and longitude, navigation data, etc.). The motion sensor 304c may obtain motion information 306c. The light sensor 304d may obtain ambient light information 306d. The audio sensor 304e may obtain audio information 306e. The sensor information 306a-e may be provided to the context obtainer 312.

The location sensor 304b may produce location information 306b. In one example, the location sensor 304b includes a GPS receiver that calculates latitude and longitude coordinates of the electronic device 302 based on received GPS satellite signals. In another example, the location sensor 304b may determine the location of the electronic device 302 by measuring wireless network (e.g., cellular, Wi-Fi, etc.) signals. The processor 314 may determine a location by searching a database of wireless network locations. For instance, the electronic device 302 may receive beacon signals from three wireless networks with known locations and determine a location of the electronic device 302 by comparing signal strength measurements that indicate the proximity of the electronic device 302 to the known wireless network locations. The location information 306b may include coordinates. In some configurations, the processor 314 (e.g., context obtainer 312) may determine geographical locations (e.g., country, state, county, city, town, region, street address, etc.) based on the location information 306b.

In some configurations, the processor 314 (e.g., context obtainer 312) may determine additional information corresponding to the location information. For example, the context obtainer 312 may utilize coordinates of the location information 306b to determine whether the electronic device 302 is currently at a user's home, work, at a gym, at a shopping center, a grocery store, a restaurant, in a particular country, state, city, county, town, park and/or recreational area (e.g., national park, tourist attraction, wilderness area, beach, ski resort, etc.), etc. In some configurations, processor 314 (e.g., context obtainer 312) may send a request (via the communication interface 316, for example) to a remote device (e.g., server) to determine one or more businesses, recreational areas, etc., that are in the current proximity of the electronic device 302 and/or if the electronic device 302 is nearby or inside of a structure (e.g., business such as a mall, restaurant, grocery store, retail store, etc.). Additionally or alternatively, the processor 314 (e.g., context obtainer 312) may determine whether the electronic device 302 is traveling along a particular route (e.g., road, highway, interstate, trail, etc.).

The motion sensor 304c (e.g., one or more accelerometers) may provide motion information 306c. The motion information 306c may indicate the motion of the electronic device 302. For example, the motion information 306c may indicate whether the electronic device 302 is stationary or moving and/or a pattern of motion. In some configurations, for example, the context obtainer 312 may perform motion recognition on the motion information and/or classify the motion information. For example, the context obtainer 312 may determine whether the user of the electronic device 302 is walking, jogging, running, exercising and/or traveling (in a car, train, boat, airplane, etc.), etc. For instance, the context obtainer 312 may determine whether the motion information 306c most closely matches an acceleration and/or motion profile corresponding to a particular activity. In particular, as a user jogs, the motion information 306c may indicate that the electronic device 302 is moving within a range of speeds for jogging and/or that the electronic device 302 is bouncing in a pattern characteristic of jogging.

The light sensor 304d may provide ambient light information 306d. The ambient light information 306d may indicate an amount of ambient light being captured by the light sensor 304d. In some configurations, the context obtainer 312 may classify the ambient light information 306d. For example, the light sensor 304d may provide light condition information. In some configurations, the context obtainer 312 may classify the ambient light information (e.g., light condition information) as an indoor light condition or an outdoor light condition. Accordingly, the suggested contact generator 310 may take indoor and outdoor contexts (e.g., scenarios) into account (when generating suggested contacts, for example). For instance, it may be more likely that a user may want to call a jogging partner when the ambient light information 306d indicates an outdoor light condition.

The audio sensor 304e (e.g., one or more microphones) may provide audio information 306e. In some configurations, the context obtainer 312 may perform audio recognition on the audio information 306e and/or classify the audio information 306e. For example, the audio recognition may detect (e.g., identify, recognize, etc.) information such as speech, speaker identity (e.g., electronic device 302 user), speaker gender, emotion (e.g., happy, sad, excited, tired, etc.), music, media soundtrack, product jingles, sound effects, spoken information (e.g., phone number, email address, street address, product name, product brand, Internet address (e.g., web link), name, title and/or media information (e.g., movie title, song title, artist name, television program name, etc.)), etc.

The communication interface 316 may provide network information 334 to the processor 114 (e.g., context obtainer 312). Examples of the network information 334 include connected network indicator(s) and network communication(s).

It should be noted that one of more of the types of information described herein (as described in connection with one or more of FIGS. 1-21, for example) may be optional. More, fewer and/or other types of information may be utilized. In some configurations, one or more of the types of information described herein (e.g., temporal information 329, image information 306a, location information 306b, motion information 306c, ambient light information 306d, audio information 306e and/or network information 334, etc.) may be stored in the memory 320 as historical operating context information 308b.

As illustrated in FIG. 3, the processor 314 may include and/or implement one or more applications 336. Examples of applications 336 include web browsers, email applications, scheduling/calendaring applications, games, dialer applications, text messaging applications, instant messaging applications, Voice Over Internet Protocol (VOIP) applications, video call applications, teleconferencing applications, productivity applications, etc. In some configurations, the application(s) 336 may provide application information 338 to the context obtainer 312. Examples of application information 338 include browsing data, search terms, calendar entries, scheduled appointments, etc.

The context obtainer 312 may provide the temporal information 329, image information 306a, location information 306b, motion information 306c, ambient light information 306d, audio information 306e, network information 334 and/or application information 338 to the suggested contact generator 310 as all or part of current operating context information 330. Additionally or alternatively, the context obtainer 312 may provide other information that may be determined based on one or more kinds of information 329, 306a-e, 334, 338 to the suggested contact generator 310 as all or part of current operating context information 330. For example, the context obtainer 312 may provide event information based on the temporal information 329 and application information 338.

The suggested contact generator 310 may generate one or more suggested contacts based on the current operating context information 330, the historical operating context information 308a and/or contact information (e.g., the locally stored contact(s) 322b and/or remotely accessed contact(s)). This may be accomplished as described in connection with one or more of FIGS. 1-2.

In some configurations, the suggested contact generator 310 may determine one or more suggested contacts based on historical operating context information 308. For example, the historical operating context information 308 may include a record of selected contacts with corresponding operating context information. The historical operating context information 308 may be based on and/or include the sensor information 306, temporal information 329, network information 334 and/or the application information 338. For instance, the historical operating context information 308 may include statistics (e.g., counts of) of selected contacts in connection with the operating context information. The historical operating context information 308 may be an example of the historical operating context information 108 described in connection with FIG. 1. In some configurations, the historical operating context information 308 may be expressed as a number of times that a contact has been selected and/or the context(s) in which the contact has been selected. One or more of these counts may be associated with operating context information, such as when at a particular location, at a particular time, when moving in a particular way, etc.

In some configurations, if the historical operating context information 308 does not contain any existing (e.g., previous) data for a particular contact and/or context, the suggested contact generator 310 may suggest one or more contacts based on the current operating context information 330 without the historical operating context information 308b and/or may suggest one or more default contacts. The default contact(s) may be based on the temporal information 329, the sensor information 306a-e, the network information 334 and/or the application information 338. For example, if the current operating context information indicates an emergency, the suggested contact generator 310 may suggest one or more emergency numbers (e.g., 911, hospital emergency, police, fire department, poison control, etc.). In some configurations, one or more default contacts may be stored in the memory 320.

In some configurations, the suggested contact generator 310 may include a contact score calculator 332. The contact score calculator 332 may calculate a relevance score, a contextual similarity and/or a selection probability for one or more contacts (e.g., locally stored contact(s) 322b and/or remotely accessed contact(s)). This may be accomplished as described in connection with FIG. 1. In some configurations, the contact score calculator 332 may calculate a joint score based on one or more of the relevance score, the contextual similarity and/or the selection probability. In some approaches, the relevance score, the contextual similarity and/or the selection probability may be weighted to provide greater or lesser weight to the relevance score, the contextual similarity and/or the selection probability in generating the suggested contact(s). As described in connection with FIG. 1, the suggested contacts may be ranked or prioritized based on the relevance score, contextual similarity and/or selection probability. The suggested contact(s) may be provided to the contact manager 326.

In some configurations, the suggested contact generator 310 may prioritize the one or more suggested contacts and/or applications by associating weights with the contact(s). For example, a higher weight may be associated with contacts that have been selected more times than other contacts. For example, if a contact has been used many times for a phone call, the contact may be weighted higher for contexts when the contact may be selected. Accordingly, prioritizing or ranking the one or more suggested contacts may be accomplished by associating weights based on a number of times a contact is selected (according to the historical operating context information 308).

In some configurations, the priority or ranking of the suggested contacts may be based on a counter. For example, each time a contact is selected in a particular context, the processor (e.g., suggested contact generator 310, contact manager 326, etc.) may increment (e.g., add a value to) the counter of the corresponding contact for that context. When the context occurs again (as indicated by the temporal information 329, network information 334, application information 338 and/or one or more of the sensor information 306a-e), the suggested contact(s) 312 may be ranked in accordance with the count. For example, if a first contact is selected more than a second contact in a particular context, the suggested contact generator 310 may prioritize the first contact above the second contact. In some configurations, the first contact may accordingly be communicated to a user more prominently (e.g., at the top of a list, in bold text, in underlined text and/or highlighted in a color, etc.) than the second contact.

In some configurations, the ranking (which may be indicated in a ranking table, list, etc.) may be based on a contact selection probability. The contact selection probability may be calculated by the contact score calculator 332. For example, the contact score calculator 332 may rank contacts in accordance with a probability that the contacts will be selected for a context. Each contact selection probability may be calculated based on current operating context information 330 and the historical operating context information 308.

The contact manager 326 may perform one or more operations based on the suggested contact(s) as described in connection with FIG. 1. For example, the contact manager 326 may provide the suggested contact(s) (e.g., prioritized suggested contacts) for communication. In some configurations, one or more of the suggested contact(s) may be communicated (e.g., presented on the display 324, indicated with audio (e.g., read as speech, with an audio chime, etc.) to a user. For example, the electronic device 302 may present an indicator of one or more of the suggested contacts as a button, icon and/or text on a touch screen display 324. In some configurations, one or more of the suggested contacts may be communicated to the user in accordance with the prioritizing and/or ranking. For example, a highest ranked suggested contact may be communicated more prominently (e.g., first on a list, highlighted in a color, displayed in bold text, etc.) than one or more of the other suggested contacts. Additionally or alternatively, only a limited number (e.g., up to three) of suggested contacts may be communicated. For example, only the suggested contacts with the three highest ranking scores may be communicated. In some configurations, the number of communicated suggested contacts may be configurable. Additionally or alternatively, the number of communicated suggested contacts may be based on an amount of display space available and/or an amount of time.

The contact manager 326 may perform additional or alternative operations based on the contact(s) (e.g., locally stored contact(s) 322, remotely accessed contact(s) and/or suggested contact(s)) as described in connection with FIG. 1. As illustrated in FIG. 3, the processor 314 (e.g., context obtainer 312, suggested contact generator 310 and/or contact manager 326) may receive input 340 (e.g., user input). For example, the electronic device 302 may receive a contact selection indicator based on user input (e.g., touch, mouse click, speech, motion, etc.), which may be provided to the contact manager 326. The contact selection indicator may indicate a selection of one or more contacts for performing an operation (e.g., phone call, text message, email, contact storage, etc.). The contact manager 326 may perform the operation. Additionally or alternatively, the contact manager 326 may run (e.g., open, call and/or execute) one or more applications 336 to perform one or more operations based on the selected contact. For example, the electronic device 302 may perform the operation by opening (or switching to) an application 336 that performs the operation and performing the operation based on the selected contact.

More specifically, for example, the contact manager 326 may select one or more contacts (e.g., one or more suggested contacts and/or other contacts) based on the received input 340. For instance, the electronic device 302 may detect that a user has tapped some text or an icon that indicates a particular contact. The contact indicated by the user input 340 may be one or more of the suggested contacts or other contact(s). The contact manager 326 may indicate the selected contact 318 (to the suggested contact generator 310, to the memory 320 and/or to one or more applications 336, for example).

In some configurations, the contact manager 326 may select an operation based on a received input 340 (e.g. user input). For example, the electronic device 302 may receive a user input (e.g., a tap and/or swipe on a touch screen, a mouse click event, a speech recognition input, a motion input, a tilt input, etc.) that indicates a particular operation for one or more contacts. For instance, the electronic device 302 may detect that a user has tapped some text or an icon associated with a suggested contact or another contact that indicates a particular operation (e.g., phone call, text message, email, store contact, edit contact, etc.). In some configurations, the contact manager 326 may run a dialer application, a text message application, an email application and/or a contacts application.

In some configurations, the processor 314 (e.g., context obtainer 312, suggested contact generator 310 and/or contact manager 326) may update the historical operating context information 308 based on the contact selection. For example, context obtainer 312 may store the current operating context information 330 (associated with one or more contacts, for example) as an update to the historical operating context information 308. In some configurations, the contact manager 326 may update the historical operating context information 308 by storing an indication of whether one or more of the contacts (e.g., locally stored contact(s) 322, remotely accessed contact(s) and/or suggested contact(s)) were selected. In some configurations, the processor 314 (e.g., contact manager 326, suggested contact generator 310, etc.) may record the selected suggested contact (e.g., update a count and/or suggested contact selection probability corresponding to the selected suggested contact) with the corresponding operating context information (e.g., sensor information 306, information based on the sensor information 306, temporal information 329, network information 334, application information 338, etc.). In some cases, the locally stored contacts 322b may not include an existing (e.g., previous) record of the selected contact. In some approaches, the historical operating context information 308 may create a new contact in the locally stored contacts 322b to reflect the newly selected contact. In this way, the processor 314 (e.g., contact manager 326, suggested contact generator 310, etc.) may flexibly update the contacts 322b.

In some configurations, the contact manager 326 may provide data to the one or more applications 336. For example, the suggested contact generator 310 may provide data based on the selected contact. For example, the selected contact may be provided to a phone dialer application, a text messaging application, an email application, etc.

In some configurations, associating the current operating context information 330 with the contact information (e.g., contacts 322a-b) and updating the historical operating context information 308b may be performed jointly. For example, associating the current operating context information 330 with contact information and updating the historical operating context information 308b may be carried out by storing the current operating context information 330 in a data structure in the memory 320 that is associated with one or more contacts (e.g., contacts 322b). The current operating context information 330 may be added to other instances of historical operating context information 308b that have been previously stored in association with the contact information (e.g., one or more contacts 322b). It should be noted that updating the historical operating context information 308b may include additional or alternative procedures in some configurations. For example, updating the historical operating context information 308b may include determining a statistical distribution as described herein, where the statistical distribution may be added to and/or adjusted based on the current operating context information 330.

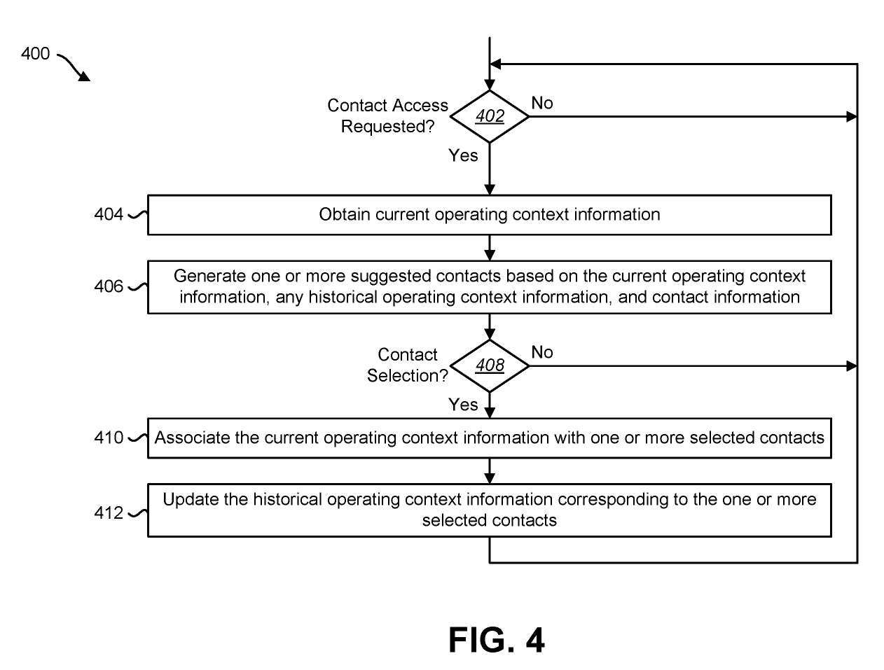

FIG. 4 is a flow diagram illustrating a more specific configuration of a method 400 for context-based contact suggestion. One or more of the electronic devices 102, 302 described in connection with one or more of FIGS. 1 and 3 may perform the method 400 in some configurations.

The electronic device 102 may determine 402 whether contact access is requested. For example, the electronic device 102 may determine whether an input has been received indicating a request to access one or more contacts. For instance, the electronic device 102 may determine whether a touch input, mouse click, key press, etc., has been received that indicates a request to access one or more contacts. This may occur when a user manipulates a smartphone to access a list of contacts (and/or draft a text message, make a phone call, draft an email, etc.), for example. If no contact access is requested, the electronic device 102 may await a contact access request.

If contact access is requested, the electronic device 102 may obtain 404 current operating context information. This may be accomplished as described in connection with one or more of FIGS. 1-3, for example.

The electronic device 102 may generate 406 one or more suggested contacts based on the current operating context information, any historical operating context information, and contact information. This may be accomplished as described in connection with one or more of FIGS. 1-3, for example.

The electronic device 102 may determine 408 whether a contact selection has occurred. For example, the electronic device 102 may determine whether an input has been received indicating one or more contacts (e.g., one or more of the suggested contact(s) and/or other contacts). For instance, the electronic device 102 may determine whether a touch input, mouse click, key press, etc., has been received that indicates a one or more contacts. This may occur when a user manipulates touches a displayed contact on a touchscreen, for example. If no contact selection has occurred (e.g., if contact selection is aborted and/or times out), the electronic device 102 may return to awaiting a contact access request.

If a contact selection has occurred, the electronic device 102 may associate 410 the current operating context information with one or more selected contacts. This may be accomplished as described in connection with one or more of FIGS. 1-3. For example, the electronic device 102 may link the current operating context information (e.g., one or more operating context parameters, an operating context parameter vector, etc.) with one or more contacts.

The electronic device 102 may update 412 the historical operating context information corresponding to the one or more selected contacts. This may be accomplished as described in connection with one or more of FIGS. 1-3. For example, updating 412 the historical operating context information may include adding the current operating context information to any pre-existing historical operating context information. In some configurations, the electronic device 102 may determine a statistical distribution based on the current operating context information and/or add the current operating context information to a pre-existing statistical distribution for one or more contacts.

As illustrated in FIG. 4, the method 400 may repeat. In some configurations, the method 400 may repeat for each contact access and/or contact selection.

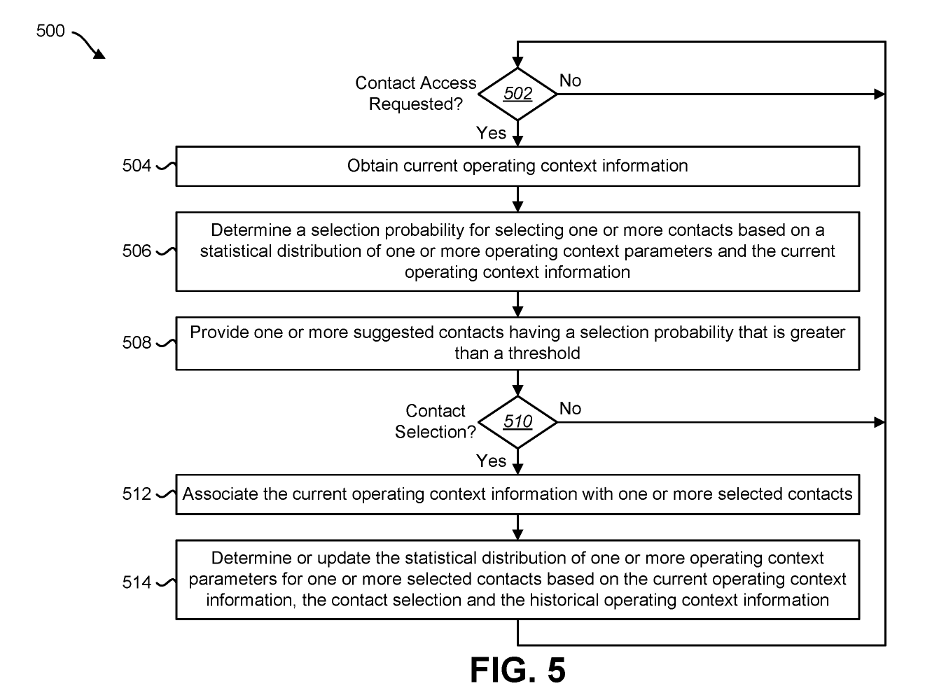

FIG. 5 is a flow diagram illustrating another more specific configuration of a method 500 for context-based contact suggestion. One or more of the electronic devices 102, 302 described in connection with one or more of FIGS. 1 and 3 may perform the method 500 in some configurations.

The electronic device 102 may determine 502 whether contact access is requested. This may be accomplished as described in connection with FIG. 4, for example.

If contact access is requested, the electronic device 102 may obtain 504 current operating context information. This may be accomplished as described in connection with one or more of FIGS. 1-4, for example.

The electronic device 102 may determine 506 a selection probability for selecting one or more contacts based on a statistical distribution of one or more operating context parameters and the current operating context information. This may be accomplished as described in connection with one or more of FIGS. 1 and 3.

The electronic device 102 may provide 508 one or more suggested contacts having a selection probability that is greater than a threshold. This may be accomplished as described in connection with FIG. 1. For example, the electronic device 102 may select one or more contacts that have a selection probability greater than a threshold as suggested contacts. In some configurations, the suggested contact(s) may be presented on a display.

The electronic device 102 may determine 510 whether a contact selection has occurred. This may be accomplished as described in connection with one or more of FIGS. 1 and 4, for example. If no contact selection has occurred (e.g., if contact selection is aborted and/or times out), the electronic device 102 may return to awaiting a contact access request.

If a contact selection has occurred, the electronic device 102 may associate 512 the current operating context information with one or more selected contacts. This may be accomplished as described in connection with one or more of FIGS. 1-4.

The electronic device 102 may determine or update 514 the statistical distribution of one or more operating context parameters for one or more selected contacts based on the current operating context information, the contact selection and the historical operating context information. This may be accomplished as described in connection with one or more of FIGS. 1-3. For example, if a statistical distribution has not been yet been determined for a selected contact, the electronic device 102 may determine a statistical distribution of one or more operating context parameters from the current operating context for the selected contact. For instance, the electronic device 102 may store the operating context parameter(s) of the current operating context information as the historical operating context information in memory. The value(s) of the operating parameter(s) from the current operating context information may establish a sample for the statistical distribution. If a statistical distribution already exists for the selected contact, the electronic device 102 may update 514 the statistical distribution based on the operating context parameter(s) of the current operating context information. For example, the electronic device 102 may add the current operating context information to the historical operating context information for the selected contact(s).

As illustrated in FIG. 5, the method 500 may repeat. In some configurations, the method 500 may repeat for each contact access and/or contact selection.

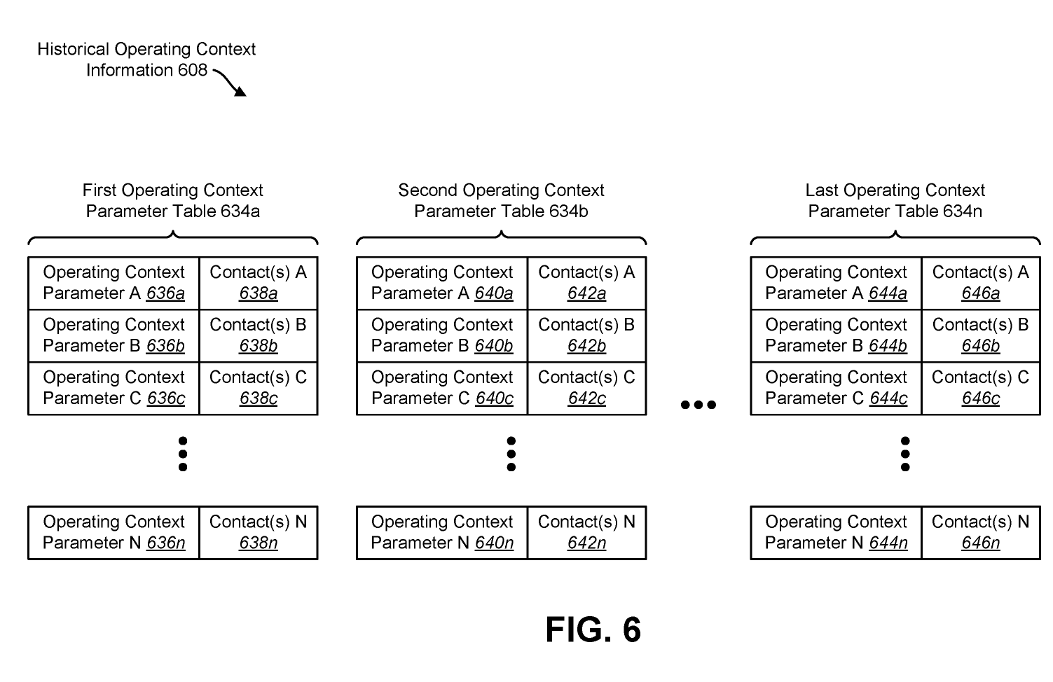

FIG. 6 is a diagram illustrating an example of historical operating context information 608 that may be utilized in accordance with the systems and methods disclosed herein. One or more of the electronic devices 102, 302 and/or methods 200, 400, 500 disclosed herein may employ one or more operating context parameter tables (e.g., historical operating context parameter tables) in generating one or more suggested contacts, associating current operating context information with contact information and/or updating historical operating context information. FIG. 6 provides an example of operating context parameter tables that may be utilized in accordance with the systems and methods disclosed herein.

In particular, FIG. 6 illustrates examples of operating context parameter tables 634a-n. The operating context parameter tables 634a-n may include operating context parameters 636a-n, 640a-n, 644a-n (e.g., historical operating context parameters). For example, a first operating context parameter table 634a includes operating context parameters A-N 636a-n and contact(s) A-N 638a-n. A second operating context parameter table 634b includes operating context parameters A-N 640a-n and contact(s) A-N 642a-n. A last operating context parameter table 634n includes operating context parameters A-N 644a-n and contact(s) A-N 646a-n. It should be noted that the operating context parameter tables 634a-n may be the same size or different sizes. The operating context parameter tables 634a-n may include a number of previously selected contacts with corresponding previously stored operating contextual parameters.

Each of the operating context parameter tables 634a-n may correspond to a type of operating context parameter. For example, the first operating context parameter table 634a may be a time-based table, the second operating context parameter table 634b may be a location-based table and the last operating context parameter table 634n may be a health-based table.

Each entry (e.g., row) of the operating context parameter tables 634a-n may correspond to an instance of operating context information. For example, operating context parameter A 636a may include and/or indicate a particular time when one or more contacts were selected and/or when an operation (e.g., phone call, text message, email, etc.) was initiated based on one or more selected contacts. Corresponding contact(s) A 638a may include, indicate and/or refer to (e.g., include an association, link, pointer, etc.) one or more selected contacts at the time indicated by operating context parameter A 636a. For example, contact(s) A 638a may refer to one or more locally stored contacts 122 and/or one or more remotely accessed contacts. Continuing with the example, operating context parameter A 640a in the second operating context parameter table 634b may indicate a location where corresponding contact(s) A 642a were selected.

Generating the one or more suggested contacts may include searching one or more operating context parameter tables. For example, the electronic device 102 may search each of the operating context parameter tables 634a-n based on the current operating context information (e.g., one or more current operating context parameters). The operating context parameters 636a-n, 640a-n 644a-n in each of the operating context parameter tables 634a-n may be utilized as a key in the search. One or more contacts 638a-n, 642a-n, 646a-n corresponding to matching (e.g., exactly matching and/or matching within a range) operating context parameters 636a-n, 640a-n 644a-n may be the results of the search. All of the results or a subset of the results may be provided as suggested contacts. For example, only results within one or more threshold amounts of operating context parameter differences or distances may be provided as suggested contacts. Additionally or alternatively, only a number of the top (e.g., most closely matching results) may be provided as suggested contacts.

In a more specific example, the electronic device 102 may search times in the first operating context parameter table 634a based on a current time (from the current operating context information), may search locations in the second operating context parameter table 634b based on a current location (from the current operating context information) and/or may search health indicators in the last operating context parameter table 634n based on a current health indicator (from the current operating context information).

One or more of the contacts resulting from the search may be provided as suggested contacts. For example, one or more contacts with corresponding context parameters that most closely match the current operating context information may be provided as suggested contacts. In some approaches, the suggested contacts may be prioritized based on how closely the context parameter(s) in the historical operating context information 608 match the current operating context parameters, with closer matches getting priority. Additionally or alternatively, one or more of the operating context parameter tables 634a-n may be prioritized (e.g., weighted). The table priority (e.g., weight) may be indicated by a global prioritization table. For example, contact(s) from a health-based table may be prioritized over contact(s) from a location-based table. This prioritization (e.g., weighting) may be one factor amongst others (e.g., closeness of a match, etc.) in determining the final priority of the suggested contacts.

Associating the current operating context information with the contact information may include linking one or more selected contacts (e.g., contact reference, link, pointer, etc.) in one or more operating context parameter tables. For example, the electronic device 102 may create contact N 638n as a reference (e.g., link, pointer, etc.) to a selected contact. Updating the historical operating context information may include storing one or more operating context parameters (e.g., current operating context parameters) associated with the selected contact(s) in one or more operating context parameter tables. For example, the electronic device 102 may store operating context parameter N 646n (e.g., a time) from the current operating context information along with the associated contact N 636n (e.g., a selected contact at the time).

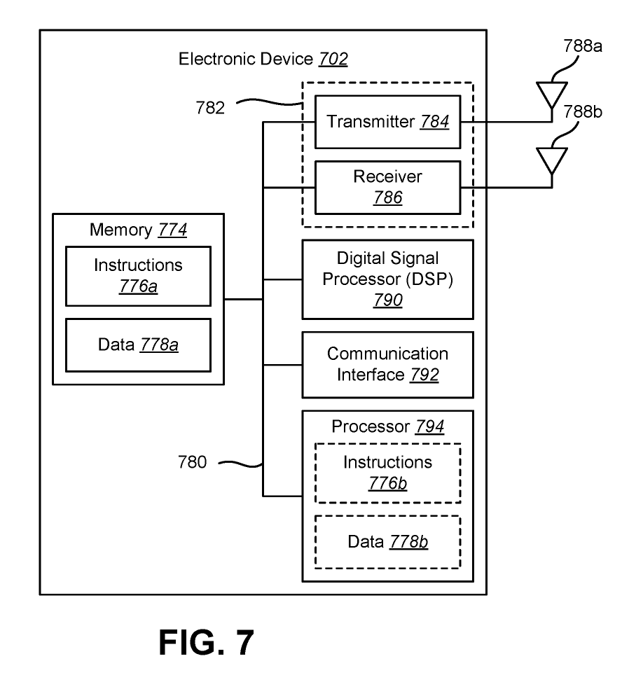

FIG. 7 illustrates certain components that may be included within an electronic device 702. The electronic device 702 described in connection with FIG. 7 may be implemented in accordance with one or more of the electronic devices 102, 302 described herein. The electronic device 702 may be an access terminal, a mobile station, a user equipment (UE), a smartphone, a digital camera, a video camera, a tablet device, a laptop computer, etc. The electronic device 702 includes a processor 794. The processor 794 may be a general purpose single- or multi-chip microprocessor (e.g., an advanced reduced instruction set computing (RISC) machine (ARM), a special purpose microprocessor (e.g., a digital signal processor (DSP)), a microcontroller, a programmable gate array, etc. The processor 794 may be referred to as a central processing unit (CPU). Although just a single processor 794 is shown in the electronic device 702, in an alternative configuration, a combination of processors (e.g., an ARM and DSP) could be used.

The electronic device 702 also includes memory 774. The memory 774 may be any electronic component capable of storing electronic information. The memory 774 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 778a and instructions 776a may be stored in the memory 774. The instructions 776a may be executable by the processor 794 to implement one or more of the methods 200, 400, 500 described herein. Executing the instructions 776a may involve the use of the data 778a that is stored in the memory 774. When the processor 794 executes the instructions 776, various portions of the instructions 776b may be loaded onto the processor 794 and/or various pieces of data 778b may be loaded onto the processor 794.

The electronic device 702 may also include a transmitter 784 and a receiver 786 to allow transmission and reception of signals to and from the electronic device 702. The transmitter 784 and receiver 786 may be collectively referred to as a transceiver 782. Multiple antennas 788a-b may be electrically coupled to the transceiver 782. The electronic device 702 may also include (not shown) multiple transmitters, multiple receivers, multiple transceivers and/or additional antennas.

The electronic device 702 may include a digital signal processor (DSP) 790. The electronic device 702 may also include a communication interface 792. The communication interface 792 may enable one or more kinds of input and/or output. For example, the communication interface 792 may include one or more ports and/or communication devices for linking other devices to the electronic device 702. Additionally or alternatively, the communication interface 792 may include one or more other interfaces (e.g., touchscreen, keypad, keyboard, microphone, camera, etc.). For example, the communication interface 792 may enable a user to interact with the electronic device 702.

The various components of the electronic device 702 may be coupled together by one or more buses, which may include a power bus, a control signal bus, a status signal bus, a data bus, etc. For the sake of clarity, the various buses are illustrated in FIG. 7 as a bus system 780.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims. It should also be noted that one or more steps of a method described herein may be substituted for one or more steps of another method described herein. Additionally or alternatively, one or more modules of an electronic device described herein may be substituted for one or more modules of another electronic device described herein. It should be further noted that additional or fewer steps may be utilized in any of the methods described herein and/or additional or fewer modules may be implemented in any of the electronic devices described herein.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for context-based contact suggestion performed by an electronic device, comprising:
generating one or more suggested contacts based on current operating context information, historical operating context information, and contact information by determining at least one contextual similarity between the current operating context information and historical operating context information corresponding to at least one contact;
associating the current operating context information with the contact information; and
updating the historical operating context information based on the current operating context information associated with the contact information.

2. The method of claim 1, wherein associating the current operating context information with the contact information comprises associating at least one contact of the contact information with the current operating context information corresponding to a time or a time range relative to a contact access or a contact selection.

3. The method of claim 1, wherein associating the current operating context information with the contact information comprises associating a context parameter vector corresponding to a contact access with the contact information.

4. The method of claim 1, further comprising determining a statistical distribution of at least one operating context parameter for a contact based on the historical operating context information, and wherein generating one or more suggested contacts comprises determining a selection probability for selecting the contact based on the statistical distribution and the current operating context information.

5. The method of claim 1, wherein the historical operating context information comprises one or more operating context parameter tables, and wherein determining the at least one contextual similarity comprises searching the one or more operating context parameter tables based on at least one current operating context parameter.

6. The method of claim 1, wherein generating one or more suggested contacts comprises prioritizing at least two contacts based on the current operating context information and the historical operating context information.

7. The method of claim 1, wherein generating the one or more suggested contacts is based on machine learning.

8. The method of claim 1, wherein updating the historical operating context information comprises updating machine learning.

9. The method of claim 1, wherein the historical operating context information comprises at least one of one or more times, one or more locations, one or more browsing activities, one or more days, one or more dates, one or more seasons, one or more events, one or more network indicators, one or more network communications, and one or more sensor information.

10. The method of claim 1, wherein the current operating context information comprises at least one of a time, a location, one or more browsing activities, a day, a date, a season, one or more events, one or more network indicators, one or more network communications, and one or more sensor information.

11. The method of claim 1, wherein the contact information comprises at least one of a set of locally stored contacts and one or more remotely accessed contacts.

12. The method of claim 1, further comprising generating at least one additional suggested contact based on the current operating context information and the contact information without regard to the historical operating context information.

13. An electronic device for context-based contact suggestion, comprising:
a memory configured to store historical operating context information; and
a processor configured to:
generate one or more suggested contacts based on current operating context information, the historical operating context information, and contact information by determining at least one contextual similarity between the current operating context information and historical operating context information corresponding to at least one contact;
associate the current operating context information with the contact information; and
update the historical operating context information based on the current operating context information associated with the contact information.

14. The electronic device of claim 13, wherein the processor is configured to associate at least one contact of the contact information with the current operating context information corresponding to a time or a time range relative to a contact access or a contact selection.

15. The electronic device of claim 13, wherein the processor is configured to determine a statistical distribution of at least one operating context parameter for a contact based on the historical operating context information, and wherein the processor is configured to determine a selection probability for selecting the contact based on the statistical distribution and the current operating context information.

16. The electronic device of claim 13, wherein the processor is configured to prioritize at least two contacts based on the current operating context information and the historical operating context information.

17. A computer-program product for context-based contact suggestion, comprising a non-transitory computer-readable medium having instructions thereon, the instructions comprising:
code for causing an electronic device to generate one or more suggested contacts based on current operating context information, the historical operating context information, and contact information by determining at least one contextual similarity between the current operating context information and historical operating context information corresponding to at least one contact;
code for causing the electronic device to associate the current operating context information with the contact information; and
code for causing the electronic device to update the historical operating context information based on the current operating context information associated with the contact information.

18. The computer-program product of claim 17, further comprising code for causing the electronic device to associate at least one contact of the contact information with the current operating context information corresponding to a time or a time range relative to a contact access or a contact selection.

19. The computer-program product of claim 17, further comprising code for causing the electronic device to determine a statistical distribution of at least one operating context parameter for a contact based on the historical operating context information, and code for causing the electronic device to determine a selection probability for selecting the contact based on the statistical distribution and the current operating context information.

20. The computer-program product of claim 17, further comprising code for causing the electronic device to prioritize at least two contacts based on the current operating context information and the historical operating context information.
